(19) United States
(12) Patent Application Publication
(10) Pub. No.: US 2008/0218616 A1
(43) Pub. Date: Sep. 11, 2008

(54) Method and apparatus for video acquisition

(75) Inventor: Stephan Wenger, San Francisco, CA (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/715,823

(22) Filed: Mar. 8, 2007

(51) Int. Cl. H04N 3/14

(52) U.S. Cl. 348/294; 348/E03.016

(57) ABSTRACT

A system for video acquisition has a mechanism for sensing the integrated brightness on an image sensor. When the integrated brightness at a sensor element reaches a predetermined level, a message including the spatial position of the sensor element is sent. The message may also include a timestamp indicative of the time of the message. As such, the video acquisition provides a sequence of messages. The integrated brightness can be obtained from counting the photons or measuring the electrical charges produced by the photons. When the message has been generated and sent, the photon counter or electrical charge accumulator is reset to an initial value, typically zero. It is also possible to provide the integrated brightness as sensed at a master sensor element so that the sending of messages is also based on the integrated brightness at the master sensor element.

### FIELD OF THE INVENTION

The present invention relates generally to digital video cameras and method for digital motion video acquisition.

### BACKGROUND OF THE INVENTION

In a conventional analog video camera, images are captured on a per line basis, where the “pixels” are part of the analogue signal, at a fixed time interval of for example 1/30^{th} or 1/25^{th} of a second per frame. In prior art digital video acquisition, complete images (often also denoted as frames) are captured at a predefined sampling instance in time, to allow utilizing the considerable two-dimensional, spatial redundancy in the video for compression algorithms. Most video compression algorithms operate on sequences of frames (or fields when interlace coding is desired) that are considered to be captured instantaneously at a discrete, fixed frame rate.

Capturing and processing images in sequences of frames or fields does not reflect closely to the human visual system as is known today. Thus, it is desirable to provide a different method and system for video acquisition.

### SUMMARY OF THE INVENTION

The present invention provides a method and system for video acquisition in which sensor elements in an image sensor are not being read out according to a fixed scan pattern, nor are they read out in fixed time intervals. Instead, at least some of the sensor elements include a mechanism that dictates the readout timing. More specifically, a determining means, coupled to a single sensor element or a group of sensor elements, provides a signal to a message generator when the photon count or integrated brightness sensed by those sensor elements reaches a predetermined level. In response to the signal, the message generator sends out a message indicating the time of message and the location or locations of the sensor elements in the image sensor. The predetermined level is related to an amount of light quanta or the number of photons accumulated in a sensor element. The sensed level can be determined from counting the photons or measuring the electrical charges produced by the photons. When the message has been generated and sent, the photon counter or electrical charge accumulator is reset to an initial value, typically zero. Thus, the data provided by the image sensor over time is a sequence of messages, each of which has information indicative of spatial coordinates of the sensor element and a timestamp showing the time instance of the message.

Thus, the first aspect of the present invention is a method of video acquisition for use with an image sensor to sense an integrated brightness over time of an imaging light beam, the image sensor having a plurality of sensing elements, each sensing element having a spatial position in the image sensor. The method comprises:

sensing the integrated brightness for providing a sensed level in a sensing element; and

providing a message when the sensed level reaches a pre-determined level, wherein the message includes information indicative of the spatial position of the sensing element.

The message may also include a timestamp indicating the time of message providing.

According to the present invention, the sensed level is reset to an initial level when the message has been provided. The initial level is typically zero.

The sensed level can be obtained by counting the photons in the imaging light beam over time at the sensor elements, by measuring a voltage potential caused by an effect produced by the photons in the imaging light beam, or the like.

In a different embodiment of the present invention, the image sensor further comprises a master sensor element, and the method further comprises sensing the imaging light beam at said master sensor element for establishing a reference level, so that said message providing is also based on the reference level. The reference level can be established based on the sensing of the integrated brightness of the imaging light beam at said master sensor in fixed time intervals.

When a master sensor element is used, the reference level causes a modification of said message providing such that a message is provided before the sensed level reaches the pre-determined level. The master sensor element may use a known psycho-optic principle to determine the need of a speedy transmission of messages.

A second aspect of the present invention is a video acquisition module for use with an image sensor, the image sensor comprising a plurality of sensor elements configured for sensing an integrated brightness over time of an imaging light beam. The video acquisition module comprises:

a monitoring mechanism, coupled to the sensor elements, for comparing a sensed level in a sensing element to a predetermined level; and

a message generating module, responsive to said comparing, for providing a message when the sensed level reaches the predetermined level, wherein the message comprises information indicative of the spatial position. The message may also include information indicative of a time of said providing.

According to the present invention, the video acquisition module further comprises a mechanism to reset the sensed level is reset to an initial level when the message has been provided. The module may comprise a photon counting mechanism for counting photons in the imaging light beam in order to sense of the integrated brightness, or a mechanism for measuring a voltage potential caused by an effect produced by photons on the imaging light beam in order to sense the integrated brightness.

In a different embodiment of the present invention, the image sensor further comprises a master sensor element, and the integrated brightness at the master sensor element is sensed for providing a reference level, wherein the monitoring mechanism is also configured to compare the sensed level in a sensing element to the reference level, so that the message generating module is configured for providing the message also based on such comparing. The reference level may cause the message generating module to provide the message before the sensed level reaches the pre-determined level.

The third aspect of the present invention is a video acquisition apparatus. The apparatus comprises an image sensor; and a video acquisition module as described above.

The apparatus can be a digital camera, a mobile phone or the like.

### BRIEF DESCRIPTION OF THE DRAWINGS

FIG. 1 illustrates an image sensor having a plurality of sensor elements.

FIG. 2a illustrates a timing chart showing a typical TV signal comprising frames.

FIG. 2b shows an enlarged portion of the timing chart as shown in FIG. 2a.

FIG. 3 illustrates a schematic representation of a TV signal having various synchronization markers.

FIG. 4a illustrates a schematic representation of a message flow, according to one embodiment of the present invention.

FIG. 4b illustrates an example of the message in the message flow, according to one embodiment of the present invention.

FIG. 5 is a flowchart illustrating the method of video acquisition, according to one embodiment of the present invention.

FIG. 6 illustrates an exemplary video acquisition system, according to one embodiment of the present invention.

FIG. 7 is a flowchart illustrating an exemplary algorithm for generating a message, according to one embodiment of the present invention.

FIG. 8 is a flowchart illustrating a different algorithm for generating a message, according to one embodiment of the present invention.

### DETAILED DESCRIPTION OF THE INVENTION

Currently video compression algorithms operate on sequences of frames (or fields when interlace coding is desired) that are considered to be captured instantaneously at a discrete, fixed frame rate. Based on a determination established in the past that most people cannot distinguish individual pictures anymore when those pictures are displayed in a sequence at a rate of at least 16 pictures per second, current movie frame rate is about 24 Hz, adding a comfort factor and a few other mechanical design choices to above-mentioned frame rate. However, modern research suggests a fixed frame of 24 Hz may not be optimal in that the temporal resolution of the human visual system is considerably higher, depending on the brightness of individual picture parts and the contrast between them.

The present invention provides a method and system for video acquisition in which the sensor elements include a mechanism that dictates the readout timing. Unlike the current video system wherein the camera sends out image data of a sequence of image frames read out in fixed time intervals, the camera, according to the present invention, is configured to send out a sequence of messages each of which comprises information indicative of the spatial coordinates of the sensor elements and a timestamp.

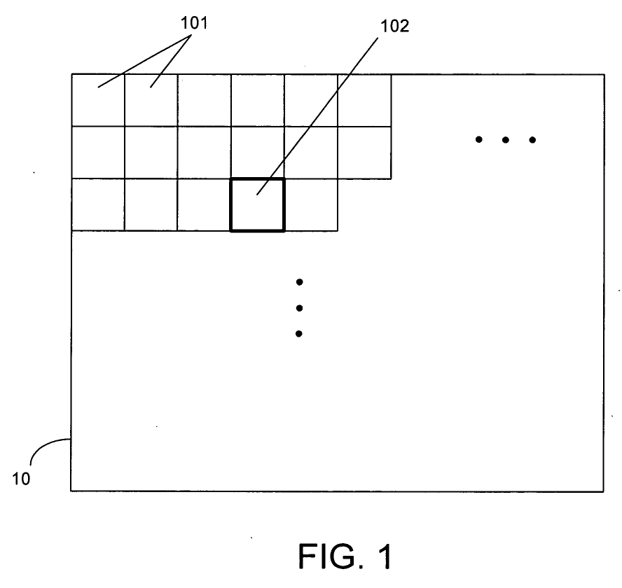

FIG. 1 shows a typical image sensor. The image sensor 10 has a plurality of sensor elements or pixels 101 for sensing the imaging light beam at various pixel locations. Each sensor element typically covers a rectangular area 102 of the optically responsive surface of the image sensor. In most cases, all sensor elements have the same spatial size and a substantially identical sensitivity to incoming photons subject to the limits of the production process. Each pixel location has different spatial coordinates. In most cases, the sensor elements are arranged in a two-dimensional matrix defined by two sets of coordinates, such as X and Y coordinates. In some cases, the matrix may be three-dimensional. For example, the sensor implements colors by stacking sensor elements responsive to certain wavelengths in the Z-dimension. The optical flow to the sensor as a whole may include filters such as a Bayer mask to enable color capture.

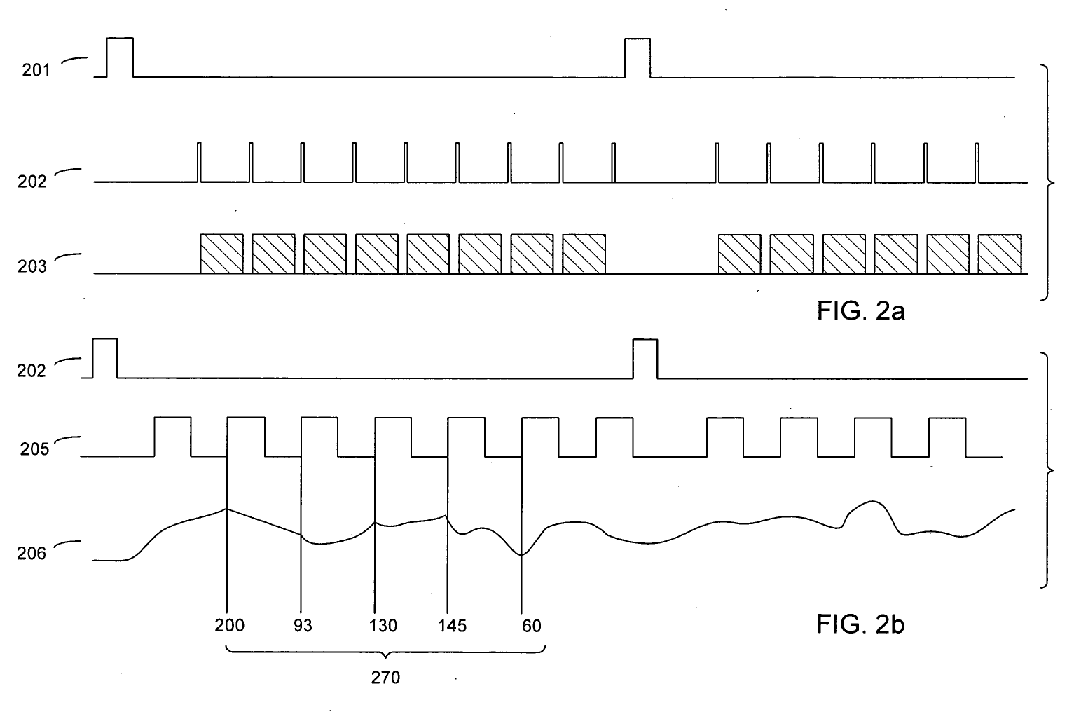

In a typical video system, the sensors elements are read out using a pre-defined scan-pattern and, in most cases, a fixed readout timing. FIG. 2a is a timing diagram showing a typical analogue TV signal with such a fixed timing. Effectively, frames are marked by a vertical synchronization (VSync) signal 201. The Vsync pulses are generated at fixed intervals. The length of these intervals depends on the television standard employed, on the use of progressive or interlace technology, and on other factors. However, in most camera designs intended for TV use, the duration lies between 1/25^{th} and 1/60^{th} of a second, yielding frame rates of 25 to 60 Hz. Specialized high-speed cameras are known to be able to handle frame rates in excess of 10 kHz. Within one frame, the sensor surface is processed in distinct lines. The start of data pertaining to a given line is signaled by a Horizontal Synchronization (Hsync) signal 202. Typically, the video signal 203 indicative of the sample value is “blanked” (forced to zero) during the synchronization pulses; either by the signal itself, or by an additional “blanking signal (not depicted). The Hsync signal follows timing constraints defined in a TV standard. Some TV signals operate on Hsync time intervals of around 64 μs, yielding Hsync frequencies around 15 kHz. With higher resolutions, the Hsync frequency is considerably higher. However, in all cases, it is fixed and pre-determined.

FIG. 2b shows an enlarged portion of the timing diagram of FIG. 2a, the period of one scan line is enlarged with the enlarged Hsync signal 202. The analogue video signal 206 is indicative to the photon count received at a particular horizontal position in the scan line. In analogue TV, this signal can be interpreted as a sliding window which moves over the whole scan line over the duration of the HSync interval.

When digital technology is involved, conceptually, the analogue video signal is sampled at discrete pixel intervals according to a sampling clock, the pixel clock 205. At standard TV resolutions, the pixel clock is in the order of magnitude of 13 MHz. At the rising edge of the pixel clock, conceptually, the analogue TV signal is sampled and Analogue to Digital converted, yielding the discrete pixel values collectively denoted by numeral 207 (here depicted assuming 8 bits of signal resolution).

To summarize, the number of accumulated photons (or a derived value that essentially depends only on the number of accumulated photons) is what the signal level for a given sensor element is based on. Sensor elements are read in constant intervals and with a constant scan pattern. Once the sensor element has been read, it resets the number of accumulated photons to zero and the process restarts.

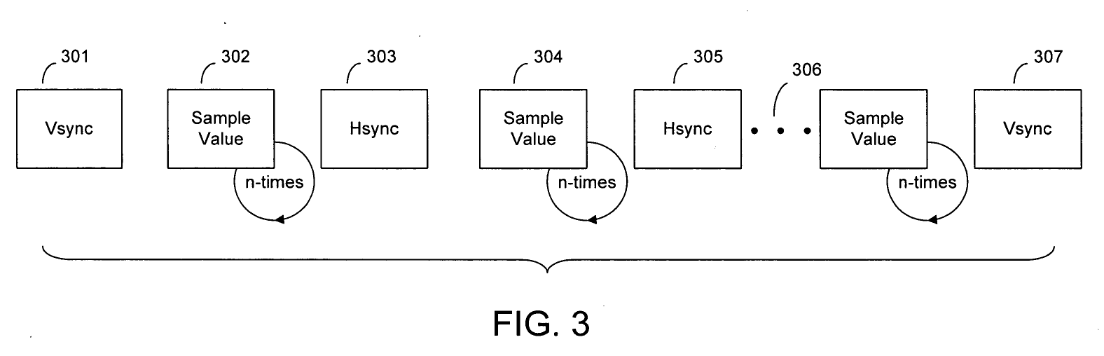

Schematically, a typical TV signal can be represented by a flow of events. As shown in FIG. 3, the events start with a Vsync event 301, followed by an event 301 conveying the brightness or intensity value for each of the n pixels within the first scan line. The scan line is, in the data flow, separated from the next scan line by a Hsync event 303. The event flow is continued with another event 304 conveying the brightness or intensity value for each of the n pixels within the second scan line and another Hsync event 305 and a number of events 306 until all scan lines have been processed. Thereafter, a Vsync event 307 is generated and the process restarts. In the time domain, the duration of each of the event types is constant in a fixed, pre-determining timing.

In contrast to the typically TV signaling scheme, the present invention does not require using a fixed scan pattern to read out the sensor elements in fixed time intervals. Instead, the present invention provides a flow of messages at non-constant time intervals.

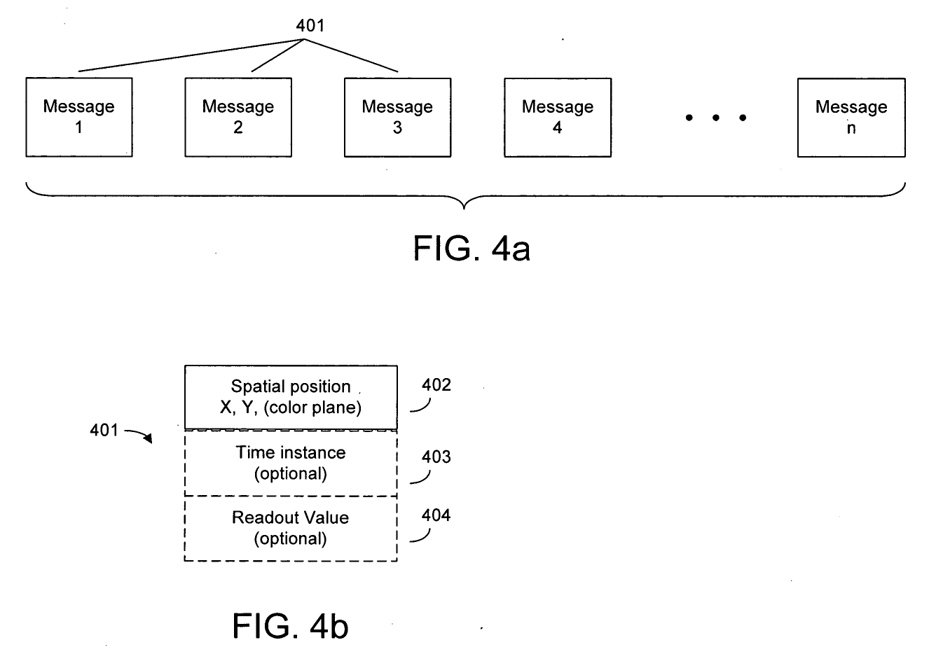

In an image sensor such as a CCD or CMOS sensor, an electrical charge is built up as the number of received photons hitting the surface of each sensor element over time. The accumulated number of photons can be sensed by measuring a current or a voltage produced by the electrical charge. In a sense, the current or voltage sensor is equivalent to a photon counter. Thus, a sensor element in an image sensor, according to the present invention, comprises a photon counter which is adapted to count the number of photons hitting the surface of that sensor element over time. The photon counter is embedded in each pixel to count the number of photons received by the opto-electronic component. When the number of photons reaches a predetermined number as determined by a comparator, a signal is provided to a message generator which provides a message of information, indicating the time of the message and the coordinates of the sensor element in the image sensor. Thus, the sensor elements in an image sensor are not being read out according to a fixed scan pattern, nor are they read out in fixed time intervals. The readout is determined by the arrival of photons on the individual sensor elements over time, and is dictated by a mechanism embedded in the image sensor. The message flow comprising a series of messages 401 is schematically represented in FIG. 4a. A typical message 410 is shown in FIG. 4b. In the message, information 402 is indicative of the spatial coordinates of the individual sensor element. Optionally, the message also includes information 403 indicative of the time instant of the readout and information 404 indicative of a readout value related to the number of photons that were received during the time interval. Whenever a message has been generated, the photon counter or its equivalent is reset to an initial value, such as zero.

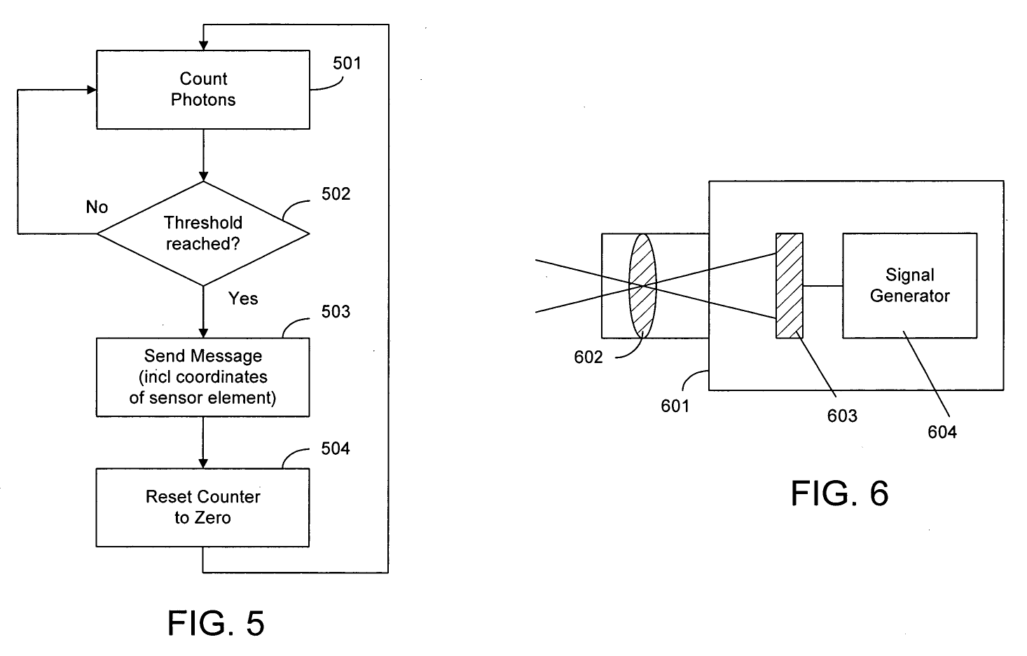

In an embodiment of the present invention, the mechanism responds to a pre-assigned threshold that is set for all sensor elements of the image sensor according to the average brightness. Once, in an individual sensor element, the threshold is reached, the message generator in the sensor element sends a message that includes coordinates of the sensor element and a timestamp. In other words, a sensor element “fires” a message of information, including at least its spatial coordinates and a timestamp, as soon as a pre-determined number of photons has been received. The algorithm is represented by a flowchart as shown in FIG. 5. The flowchart shows the photon counting and processing at a sensor element at a spatial position in an image sensor. At step 501, the number of photons is counted or the integrated brightness over time is monitored. When a threshold is reached as determined at step 502, the sensor element sends a message at step 503. The counter or brightness sensor is reset at step 504. The process loops back to photon counting at step 501. Over time, the camera signal comprises the sequenced individual messages from all sensor elements. The sequencing algorithm itself can be an aggregate of messages after adding framing information that distinguishes between the messages.

In another embodiment of the present invention, a more complex sequencing algorithm can be designed to reorder the messages such that there is a certain amount of redundancy between neighboring messages, which can be reduced utilizing loss-less compression. For example, the sequencing algorithm can take into consideration all messages received in a time interval, i.e. 1/100^{th} of a second, and reorder them in scanning order. Then, a run-length coding scheme can be used to compress the message stream, wherein run would be responsive to the number of sensor elements in scan order that did not “fire” a message in the time interval, whereas level would be the precise timing information of a sensor element that has “fired” during the time interval. Thus, the encoder can be configured to compress the message sequence from the image sensor in a run-length coding scheme.

In the above-disclosed embodiments, the signal takes into account one key aspect of the human visual system, namely that it is more responsive to fast changes in the environment when the lighting conditions are good (e.g. the photon flow is high). It is also possible to provide more complex forms of message sequencing. For example:
A sensor element may contain memory to store a “history” of timestamps of when this sensor element has “fired”. When the timestamp interval changes rapidly (indicative of a quick brightness change), the message report rate for this sensor element can be increased non-proportionally. This reflects the human visual system's alertness to sudden brightness changes.
A master sensor element may take the accumulated values of a number of accumulated photon counts from neighboring slave sensor elements, and its own value, into account to trigger a sending of messages for all the neighbors. In this case, the messages do not necessarily need to explicitly include all the spatial coordinates from values from all sensor elements but the coordinates of the master sensor element. However, in this case the readout value needs to be part of the messages for all the slaves. This can be viewed as one form of sequencing as described above, and is also an optimization in the sensor design as the amount of logic per sensor element is reduced.
In the above case, the master sensor may utilize other known psycho-optic principles to determine the need for speedy transmission of messages related to this master sensor element and its slave sensor elements. For example, if the master sensor element detects high spatial contrast in the values itself and/or its slave sensor elements it is responsible for, then it may decide to signal the readout values more frequently. Such a sensor would be more responsive to high contrast in the capture motion scene, which corresponds to one of the key findings of modern psycho-optical research.

The signal, according to the invention, comprises sequenced messages in which a single message comprises at least one of the following message elements:
spatial coordinates of the originating sensor element, either directly coded or in some implicit form (i.e. in the cited run-length coding when message re-sequencing has happened)
indication of the spatial position of the slaved sensor elements if the sensor element is a master sensor element
a value for the sensor element responsive to the number of photons received by that sensor element
time information, for example in the form of a timestamp value (absolute time), or in the form of the time interval since the last readout.

The spatial coordinates of the sensor element may be defined by integer values. Most sensors require at least two of these values for X and Y dimension. Some sensors may also require a third dimension e.g. for the color plane.

It should be noted that the indication of the spatial position can be defined as the spatial coordinates for the sensor elements above. However, more suitable representations are also possible, so as to reduce the bandwidth of the signal.

The value of a sensor element may be an integer or float value; likely the output of an A/D converter. It may also be compressed, for example by using one or more previous values as predictors. In the simplest form, the sensor element's value is coded using a binary representation. Other forms include coding difference information relative to the value conveyed in the previous message, difference information relative to the mean or median of a per-determined number of values conveyed in previous messages, and so on.

The time information may be an integer or float value. As it is known that the human visual system is responsive to large contrast changes in the time domain to frequencies as high as 500 Hz, the resolution of the time information needs to be around 2 ms or less to represent a visually lossless signal. The coding of the time information follows principles similar to the value.

The signal is generated by a video acquisition system which is referred to as a camera. FIG. 6 shows an exemplary camera that can be used with the present invention. The camera may comprise:

mechanics 601,

elements 602 of the optical flow (lenses and such),

a sensor 603 containing the sensor elements, and

circuitry 604 for generating the signal.

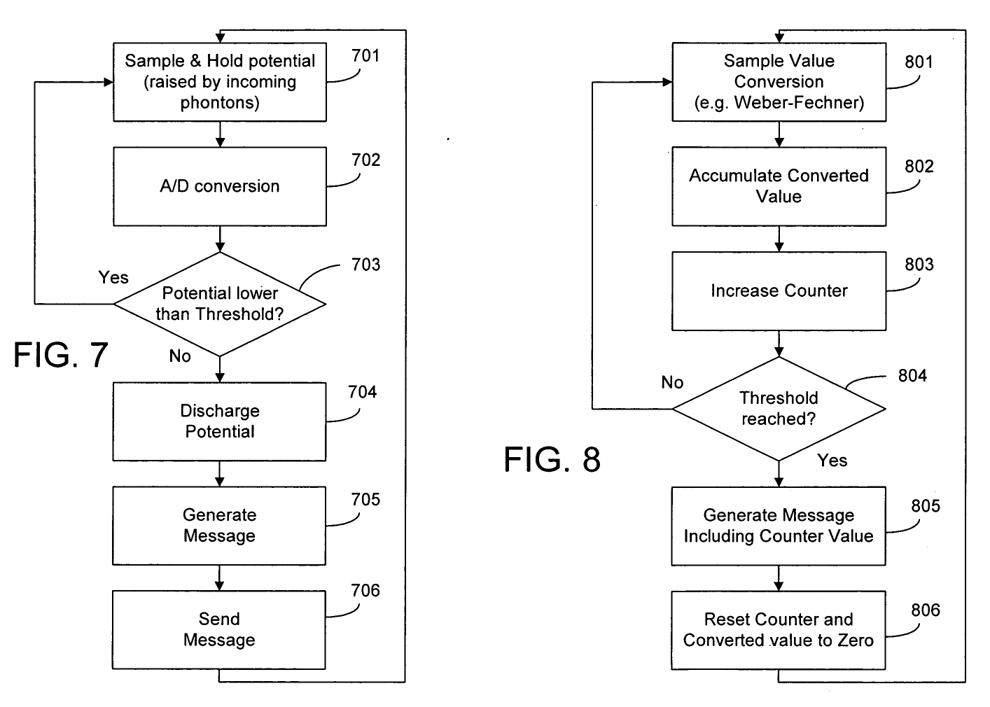

The camera can be implemented in many different forms. For example, a camera is designed to integrate the photon counters and the sensor element-specific logic on a single die, utilizing the CMOS sensor technology. The photoreceptors are located on the optically sensitive side of a CMOS die. Below them, or even on the opposite site of the die, circuitry is located that implements the message creation algorithm. The circuitry is connected (using a bus or other appropriate means) to a message interface. The message interface implements the message sequencing and generates the output signal in an appropriate physical form. The circuitry can be implemented as a synchronous state mechanism with a sufficiently high clock rate (e.g. 1 kHz), implementing an algorithm as represented by the flowchart as shown in FIG. 7. The algorithm comprises the following steps:
Sample and hold the voltage potential accumulated by the photoreceptor at step 701 (assuming that each received photon raises the potential in the photoreceptor, as it is common in some sensor designs). This forms an analogue representation of the value of the sensor element.
Optionally, the sampled value could be A/D converted into a digital representation at step 702.
If the sampled voltage potential (or its digital representation) is lower than threshold (set for the whole sensor) as determined at step 703, go back to step 701. The comparison could be implemented in analogue technology for cost efficiency or by digital means when A/D conversion is implemented.
Discharge the voltage potential, thereby resetting the analogue photon counter to zero at step 704.
Generate a message containing current timestamp, and (implicitly known and hence hard-coded) coordinates of sensor element at step 705.
Send the message to the message interface at step 706.
Go to step 701.

In another example, the circuitry of a master sensor element takes into account the A/D converted sampled (in fixed time intervals e.g. every 1 ms) potential of its own, and the corresponding values from neighboring slave sensor elements. These values can be used to decide when a message needs to be sent, based on psycho-optic criteria.

It is also possible to implement the video acquisition system, according to the present invention, in software, utilizing a high speed raster scan camera as commonly used today. This implementation can be described as the operations on a sequence of images captured at a fixed, very high frame rate. For example, the frame rate is in the order of magnitude of 500 fps. For that reason, a high-speed camera is required. In the camera, each captured image can have 8 bit sample depth and can be seen as a two-dimensional matrix (at the camera's resolution, e.g. 640×480) wherein each pixel is represented by a value between 0 and 255. Depending on the light conditions, the camera is adjusted such that the average sample value is around 100 (measure over many frames of the video sequence). In the camera/lens combination of interest, the adjustment can be made by optical means (iris size) and by electronic means (shutter speed).

FIG. 8 is a flowchart illustrating a different method for generating a message, according to the present invention. The method implements the following steps, described here for a single sample (and therefore has to be applied for each spatial position separately)
Convert the sampled value into a representation close to the human eye's perception at step 801. This could, for example, involve the application of Weber-Fechner law, which represents the relation between the magnitude of physical stimulus and the magnitude of psychological sense in human being.
Accumulate (over the course of several pictures) the converted value in an accumulator at step 802.
Increase a counter at step 803.
If the accumulator has not reached a pre-set threshold as determined at step 804, continue at step 801.
Generate a message containing the value of the counter (and the spatial position of the sample) at step 805.
Reset the counter to zero and the accumulator to zero at step 806.
Continue at step 801

The Weber-Fechner law is established based on the fact that the response of the human visual system depends much less on the absolute luminance than the relation of its local variations to the surrounding luminance. The measure of the relative variation of luminance is known as contrast. The contrast sensitivity of the human visual system can be measured using a variable called threshold contrast against a wide of luminance or intensity. The threshold contrast is the minimum contrast necessary for an observer to detect a change in the light intensity. According to the Weber-Fechner law, the threshold contrast is very high when the intensity is extremely low. The threshold contrast decreases as the light intensity increases until the light intensity reaches a certain level. After that the threshold contrast remains nearly constant over a wide range of intensities. Under optimal conditions, the threshold contrast can be less than 1%, but the exact figure depends on the light color and the spatial and temporal frequency of the stimulus.

The luminance range in which the threshold contrast is nearly constant is the range typically encountered in most image processing applications. Thus, the constant threshold contrast can be used as a guide for setting up the pre-determined level for message providing, for example. Furthermore, in order to take into account the spatial and temporal frequencies of the stimulus, the change in the integrated brightness in a sensor element is also measured against a reference brightness level provided by a “master” sensor element, for example.

In sum, the present invention provides a method of video acquisition for use with an image sensor to sense an integrated brightness over time of an imaging light beam, wherein the image sensor has a plurality of sensing elements, each sensing element having a spatial position in the image sensor. The method comprises sensing the integrated brightness for providing a sensed level in a sensing element; and providing a message when the sensed level reaches a pre-determined level, wherein the message includes information indicative of the spatial position of the sensing element and a time of providing the message.

The method further comprises resetting the sensed level to an initial level when the message has been provided. The initial level is typically zero.

The present invention also provides an image sensor for use in sensing an imaging light beam.

In a different embodiment, at least one sensor element is used as a master sensor element. The method comprises sensing the integrated brightness at said master sensor element for establishing a reference level, so that said message providing regarding the other sensor elements is also based on the reference level. According to the present invention, the reference level is established based on the sensing of the integrated brightness of the imaging light beam at said master sensor in fixed time intervals. The other sensor elements surrounding the master sensor element are considered as slave sensor elements. The master sensor element may use some known psycho-optic principles to determine the need for speedy transmission of messages. In that respect, the use of reference level may modify the timing of message providing by the slave sensor elements. When there is a high contrast between the master and the slave sensor elements, the message based on the sensed level at the slave sensor elements may be provided before the sensed level reaches a predetermined level. Thus, a psycho-optic criteria based on the difference between said reference level and the level of a slave sensor element can be used for determining whether a message is sent. Furthermore, when the change between the current sensed level and a previous sensed level is large or exceeds a pre-determined amount, a message is also provided.

Optical sensors according to the principle above can be implemented in analogue or digital form, or mixing forms. Perhaps the most common form of implementation, today, is that the addressing of the sensor elements is performed using digital signals, whereas the readout is using an analogue signal value, which may be digitized later using Analogue-Digital Converters.

Although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A method of video acquisition, comprising:
sensing the integrated brightness over time of an imaging light beam for providing a sensed level in a sensing element; and
providing a message at least whenever the sensed level reaches a pre-determined level, wherein the message includes information indicative of the spatial position of the sensing element.

2. The method of claim 1, further comprising:
including in the message a time of said providing.

3. The method of claim 1, further comprising:
including in the message a value indicative of the level.

4. The method of claim 1, wherein the sensed level is reset to an initial level when the message has been provided.

5. The method of claim 1, wherein the initial level is substantially zero.

6. The method of claim 1, wherein the imaging light beam comprises a plurality of photons, and the sensing of the integrated brightness comprises counting the photons, and wherein the sensed level is indicative of a counted number of photons encountering the sensing element.

7. The method of claim 1, wherein the imaging light beam comprises a plurality of photons, and the sensing of the integrated brightness comprises measuring a voltage potential caused by an effect produced by photons in the imaging light beam, and wherein the sensed level is indicative of a number of photons encountering the sensing element.

8. The method of claim 1, wherein the image sensor further comprises a master sensor element, said method further comprising
sensing the imaging light beam at said master sensor element for establishing a reference level, so that said message providing is also based on the reference level.

9. The method of claim 8, wherein the reference level is established based on the sensing of the integrated brightness of the imaging light beam at said master sensor in fixed time intervals.

10. The method of claim 8, wherein the reference level causes a modification of said message providing such that a message is provided before the sensed level reaches the pre-determined level.

11. The method of claim 8, wherein said message providing is also based on psycho-optic criteria.

12. The method of claim 11, wherein said psycho-optic criteria is a difference between said reference level and the level of a slave sensor element.

13. The method of claim 3, wherein a message is provided when a change between the sensed level and a previous sensed level reaches a pre-determined amount.

14. A device, comprising:
an image sensor comprising a plurality of sensor elements configured for sensing an integrated brightness over time of an imaging light beam for providing a sensed level;
a monitoring mechanism, coupled to sensor elements, for comparing a sensed level in a sensing element to a predetermined level; and
a message generating module, responsive to said comparing, for providing a message when the sensed level reaches the predetermined level, wherein the message comprises information indicative of the spatial position.

15. The device according to claim 14, wherein the message also comprises information indicative of a time of said providing.

16. The device according to claim 14, further comprising a mechanism to reset the sensed level to an initial level when the message has been provided.

17. The device according to claim 14, further comprising:
a photon counting mechanism for counting photons in the imaging light beam in order to sense the integrated brightness, wherein the sensed level is indicative of a counted number of photons encountering the sensing element.

18. The device according to claim 14, further comprising:
a mechanism for measuring a voltage potential caused by an effect produced by photons on the imaging light beam in order to sense the integrated brightness, wherein the sensed level is indicative of the measured voltage potential.

19. The device according to claim 14, wherein the image sensor further comprises a master sensor element, and the integrated brightness at the master sensor element is sensed for providing a reference level, and wherein the monitoring mechanism is also configured to compare the sensed level in a sensing element to the reference level, so that the message generating module is configured for providing the message also based on such comparing.

20. The device according to claim 19, wherein the reference level is established based on the sensing of the integrated brightness of the imaging light beam at said master sensor in fixed time intervals.

21. The device according to claim 19, wherein the reference level causes the message generating module to provide the message before the sensed level reaches the pre-determined level.

22. The device according to claim 14, comprising a digital camera.

23. The device according to claim 14, comprising a mobile phone.
